(19) United States
(12) Patent Application Publication
(10) Pub. No.: US 2008/0189794 A1
(43) Pub. Date: Aug. 7, 2008

(54) Secure Host Interface

(75) Inventors: Antonius Adriaan Maria Staring, Eindhoven (NL); Johan Cornelis Talstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,010

(22) PCT Filed: Jan. 13, 2006
(86) PCT No.: PCT/IB06/50126

§ 371 Date: Jul. 16, 2007

(30) Foreign Application Priority Data
Jan. 18, 2005 (EP) 05100278.0
Sep. 9, 2005 (EP) 05108273.3

(51) Int. Cl. G06F 21/00

(52) U.S. Cl. 726/27

(57) ABSTRACT

The present invention relates to a digital rights management system (40) for controlling access rights to copy protected content comprising an application unit (1, 21, 41) and a drive unit (3, 23, 43), to an application unit (1, 21, 41), to a drive unit (3, 23, 43) and to a corresponding digital rights management method. In order to allow an increased security in the management of digital rights, wherein in particular a “filter-driver”-hack is made impossible or is at least substantially complicated and a reliable confirmation about a command given in respect of digital rights and its execution, a digital rights management system (40) is proposed wherein said application unit (1, 21, 41) comprises a key storage unit (45) for storing a bus key (KB), a request generation unit (47) for generating a request (7, 27) to be carried out by said drive unit including a message regarding said access rights and a challenge (RX), a communication unit (51) for transmitting said request (7, 27) and for receiving a response (13, 33) to said request (7, 27) from said drive unit (3, 23, 43), a response verification unit (49) for verifying a link between said request (7, 27) and said response (13, 33) by decoding said response (13, 33) using said bus key (KB) and by checking for the presence of an indication of said challenge (RX) in said response (13, 33) and said drive unit (3, 23, 43) comprises a key storage unit (55) for storing a bus key (KB), a communication unit (51) for receiving a request (7, 27) including a message regarding said access rights and a challenge (RX) from said application unit (1, 21, 41) and for transmitting a response (13, 33) to said request (1, 21, 41), a request processing unit (57) for verifying said request (7, 27) and processing said message, a response generation unit (59) for generating said response (13, 33) including an indication of said challenge (RX) and a reply to said message, wherein said indication of said challenge (RX) and said reply are cryptographically linked by means of said bus key (KB) and wherein indication of said challenge (RX) in said response (13, 33) indicates that said request has been carried out.

The invention relates to a digital rights management system for controlling access rights to copy protected content comprising an application unit and a drive unit. The invention relates further to an application unit, a drive unit and a corresponding digital rights management method.

The rising of AACS as a strong candidate for the copy protection system on Blu-ray Disc and its competing format, HD-DVD, has revived the interest in Digital Rights Management (DRM) on optical media. One of the AACS requirements is that the system must support extended and extensible usage supporting a variety of as yet undefined business models and use cases. It must be applicable to recording and electronic download.

A similar requirement played a central role in known DRM systems where DRM data, such as decryption keys and usage rights, are stored on the disc in an area called “key locker”, as, for instance, described in WO 2002/015184-A1 (PHNL000448). The key locker is encrypted using, amongst others, a so-called hidden channel key. The hidden channel is an area on the disc that is accessible to the drive only, and which is preferably stored separate from the main data channel. In order to prevent replay attacks, the drive changes the hidden channel key whenever the data stored in the key locker changes. In a replay attack, a hacker first stores a bit image of the DRM rights on the disc to a safe place, e.g. a hard drive, subsequently consumes his/her rights which presumably are cryptographically bound to the disc, and then restores the original bit image, thereby restoring the original rights. This attack is prevented by re-encrypting the rights whenever they are consumed.

In BD-VCPS, a port of VCPS for DVD+RW (for the specifications of VCPS see http://www.licensing.philips.com/vcps, the text of this specification is hereby included by reference) to the Blu-ray Disc format, there is also provided a feature like the known hidden channel in order to support arbitrary DRM rights on the disc. In this context, the hidden channel is known as the “RE mark.” Unlike in the known DRM system, a direct interface to the RE mark is provided and there is no construct like the key locker provided. The latter may be implemented by the host application(s) if so desired. For this purpose three commands are needed that the host may use to access the RE mark key, namely read, change, and wipe.

The read command returns the RE mark key, encrypted using a previously established bus key. The change command forces the drive to randomly change the key stored in the RE mark. The wipe command forces the drive to erase the RE mark from the disc. As a further enhancement, the storage of multiple, e.g. 8, RE marks on the disc is possible. Therefore, each of these commands contains a parameter that indicates the specific RE mark on which to act.

The host interface of an optical disc drive is defined by means of the Multi-Media Command set (MMC) (see the SCSI Multi-Media Commands—4 (T10/1545D) specification, the text of this specification is hereby included by reference). The commands in this set consist of a descriptor block, which indicates the action that the drive should perform, and a parameter block (if the host sends data to the drive), or a data block (which the host receives from the drive). A single command may not specify a parameter block and a data block. At first sight, the necessary commands described above fit in this architecture, since none of them requires both a parameter block and a data block. However, without special measures, there would be a security hole. The reason is that a hacker may insert a “filter-driver” in the OS software stack of the host, which blocks and/or redirects these commands. As a result, the application running on the host cannot be certain that the RE mark on the disc has been updated (or, for that matter, retrieved from the appropriate location). Executing an authentication protocol between the drive and the host to establish a bus key, and subsequently using that bus key to encrypt command data is not sufficient by itself.

It is therefore an object of the present invention to provide a digital rights management system, an application unit, a drive unit and a corresponding digital rights management method which allow an increased security in the management of digital rights, where in particular a “filter-driver”-hack is made impossible or is at least substantially complicated. Further, there should be a reliable confirmation about a command given in respect of digital rights, e.g. a read-, write- or wipe-command as stated above, and its execution.

The object is achieved according to the present invention by an application unit for use in a digital rights management system comprising a drive unit for controlling access rights to copy protected content, said application unit comprising:

a key storage unit for storing a bus key,

a request generation unit for generating a request to be carried out by the drive unit including a message regarding said access rights and a challenge,

a communication unit for transmitting said request and for receiving a response to said request from said drive unit,

a response verification unit for verifying a link between said request and said response by decoding said response using said bus key and by checking for the presence of an indication of said challenge in said response indicating that said request has been carried out.

The object is further achieved according to the present invention by a drive unit for use in a digital rights management system comprising an application unit for controlling access rights to copy protected content, said drive unit comprising:

a key storage unit for storing a bus key,

a communication unit for receiving a request to be carried out by said drive unit including a message regarding said access rights and a challenge from said application unit and for transmitting a response to said request,

a request processing unit for processing said message,

a response generation unit for generating said response including an indication of said challenge and a reply to said message, wherein said indication of said challenge and said reply are cryptographically linked by means of said bus key and wherein indication of said challenge in said response indicates that said request has been carried out.

Still further, the object is achieved according to the present invention by a digital rights management system and a corresponding method for controlling access rights to copy protected content comprising an application unit and a drive unit as described above, wherein said bus key is shared by said application unit and said drive unit.

The present invention is further related to a computer program comprising computer program code means for causing an application unit to perform the steps a), b), e) and f) of the digital rights management method of claim 12 when said computer program is run on said application unit and to a computer program comprising computer program code means for causing a drive unit to perform the steps b) to e) of the digital rights management method of claim 12 when said computer program is run on said drive unit.

The present invention is based on the idea to use a challenge-response mechanism in all hidden channel or RE mark related commands. Basically, RE mark access is distributed over two separate commands. Using the first command, the host prepares the drive for RE mark access. This command includes a challenge, e.g. a random number generated by the host, and may include additional parameters such as an access mode (change the RE mark, read the RE mark, wipe the RE mark), and an indicator of which RE mark to act upon if the disc contains multiple RE marks. Using the second command, the host retrieves the RE mark data from the drive, as well as the random number sent with the first command. The returned RE mark data must be cryptographically bound to the random number, in order to avoid cut and paste attacks in the returned data. Accordingly, the request send by the application unit and received by the drive unit comprises a message and a challenge, wherein said message includes a command for accessing and/or processing access rights.

In an embodiment of an application unit according to the present invention said request generation unit is adapted for cryptographically linking said message and said challenge by means of said bus key. When said message and said challenge are cryptographically linked by means of said bus key, e.g. encrypted together using said bus key and/or including a hash-value derived from a combination of said message and said bus key, the recipient is able to verify that the message does indeed come from said application unit. Thus, a drive unit expecting said cryptographical link between said message and said challenge may just ignore an unlinked message and challenge since these may be used to hack said bus key by analyzing a (large) number of responses. Further, if there is no verification of the application unit, any other (unauthorized) application may destroy said hidden channel or RE mark by using the wipe command. If there are other provisions to avoid these dangers, the linking between said message and said challenge may be omitted since neither the command nor the challenge as such has been kept secret.

In another embodiment of an application unit according to the present invention said request generation unit is adapted for including a signature into said request for use in an integrity test of said request. By checking the validity of said signature the drive unit receiving said request may determine whether the request has (been) changed, e.g. during transmission, or has been received incompletely. Said signature may be a fixed or predetermined bit pattern known by both, application unit and drive unit, wherein the integrity of the request may be determined by deriving the correct signature from said request, e.g. by decoding said request. Said signature may also be a checksum, e.g. of a combination of said message and said challenge, wherein the checksum calculated by said drive unit is compared to the signature included in said request.

In a further embodiment of an application unit according to the present invention said request generation unit is adapted for encrypting said request using said bus key. Since said bus key is only known by said drive unit and said application unit, no unauthorized unit, i.e. a unit being not in possession of said bus key, will be able to take part in the digital rights management protocol according to the present embodiment.

In yet another embodiment of an application unit according to the present invention said request generation unit is adapted for including a value derived from said challenge and/or said message and said bus key by means of a hash function, in particular by means of a keyed-hash function using said bus key, into said request. Similar to the prior embodiment a request transmitted from an application unit according to the present embodiment may be verified by means of said bus key by an accordingly adapted drive unit.

In a preferred embodiment of an application unit according to the present invention said message includes a command for managing hidden channel entries, in particular a command for reading a hidden channel entry, for changing a hidden channel entry and/or for wiping a hidden channel entry. Whereas other messages may be included into said message it is preferred to protect these commands for managing hidden channel entries or RE marks against any tampering and to allow a reliable confirmation that these commands actually have been executed by the correct and authorized drive unit.

Accordingly, in a preferred embodiment of a drive unit according to the present invention said reply includes a hidden channel entry, in particular a hidden channel entry read or changed by said drive unit.

In another preferred embodiment of an application unit according to the present invention said request generation unit is adapted for including a random number, an identifier identifying said request, in particular a substantially unique identifier, and/or predetermined data as said challenge into said request. The use of a random number as said challenge has the advantage that it is not predictable, and there is virtually no other way to obtain said random number than getting it from said application unit. Another easy way to provide a challenge is to include said identifier into said request. Further, it is possible to provide said application unit with a predetermined challenge, e.g. either by providing a fixed (but preferably unique) challenge to each application unit or by having said application generating a (preferably random) number as a common challenge for a number of requests. Combinations of these possibilities may implement some of their advantages by avoiding some of their trade-offs.

In yet a further embodiment of the present invention said application unit is a host, in particular a software application. The present invention is in particular relevant to software applications which are very vulnerable in view of other malicious software applications which might step in between said application unit and said drive unit. However, it has to be noted that the present invention is also applicable to application units which are implemented in other ways, for instance as a hardware device communicating with said drive unit.

In the following the present invention will be described further in detail with reference to the accompanying figures, in which:

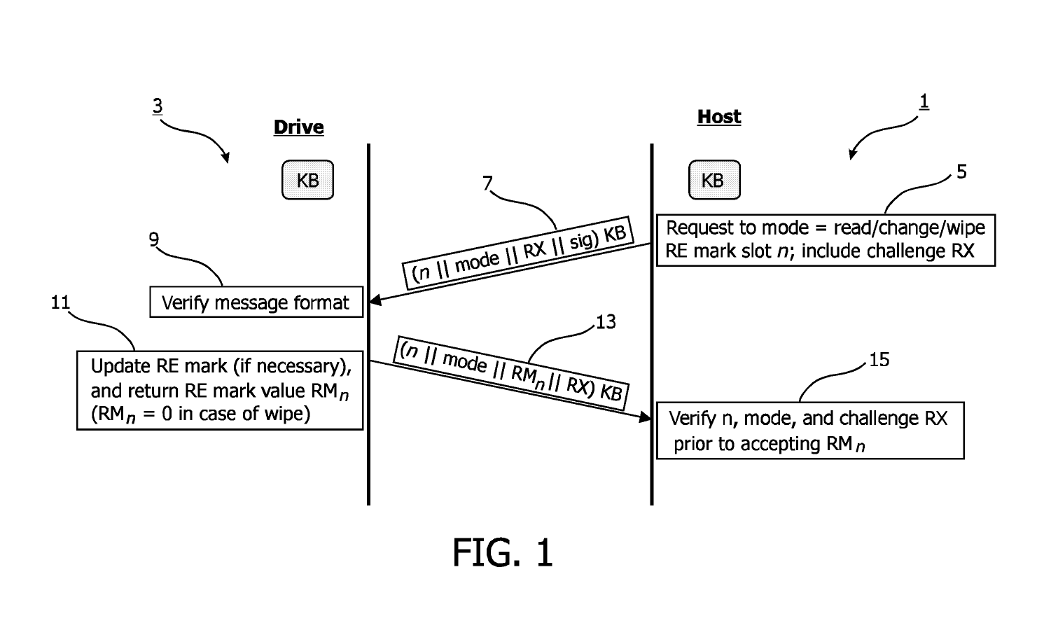

FIG. 1 shows a schematic flowchart of a first embodiment of a digital rights management method according to the present invention,

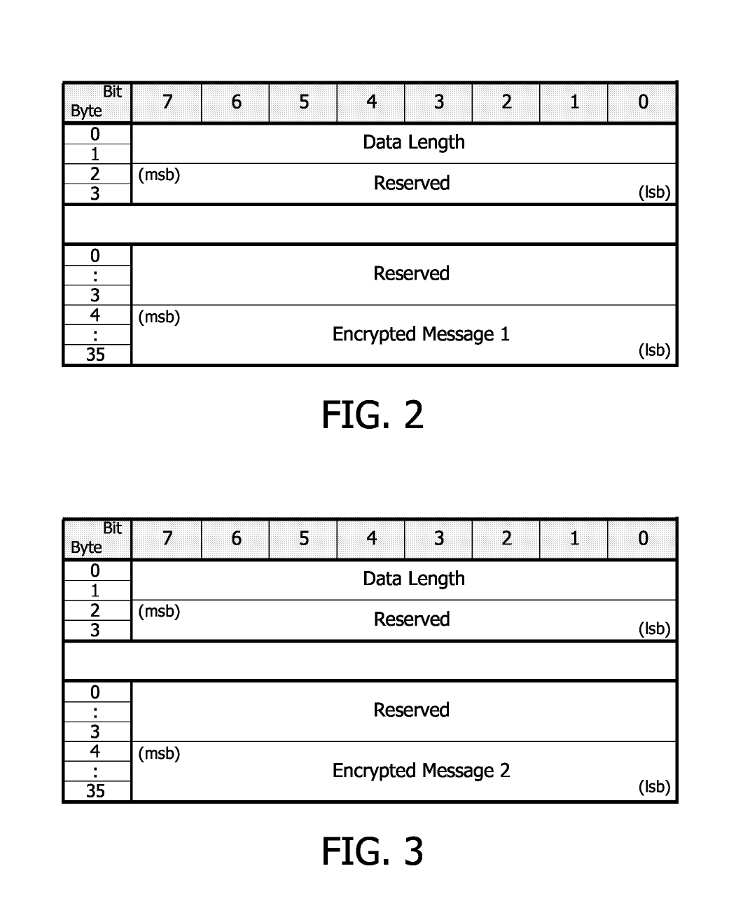

FIG. 2 illustrates the structure of the parameter data of a SEND KEY RE Mark command,

FIG. 3 illustrates the structure of the returned data of a REPORT KEY RE Mark command,

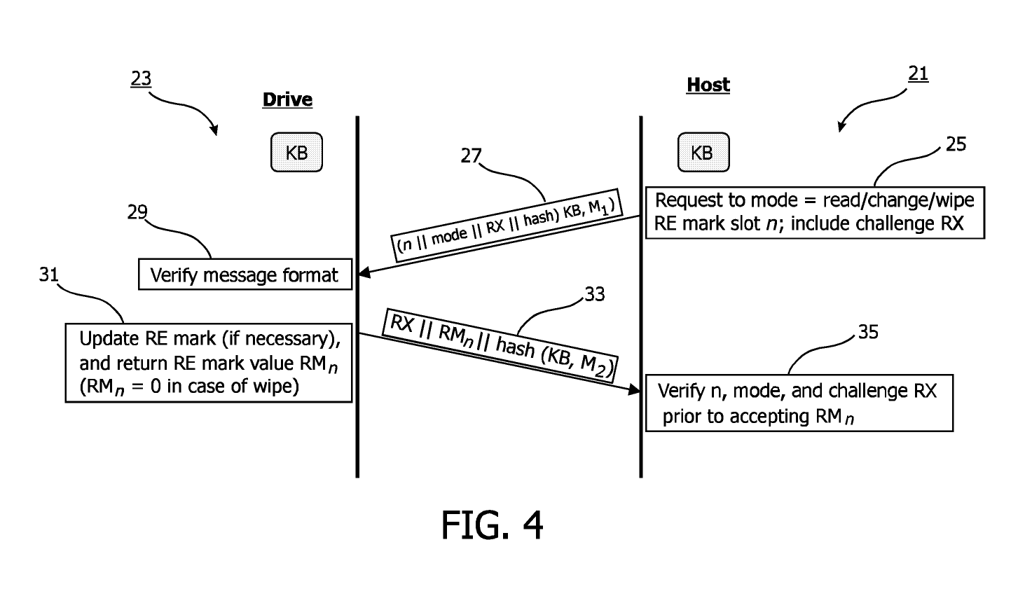

FIG. 4 shows a schematic flowchart of a second embodiment of a digital rights management method according to the present invention,

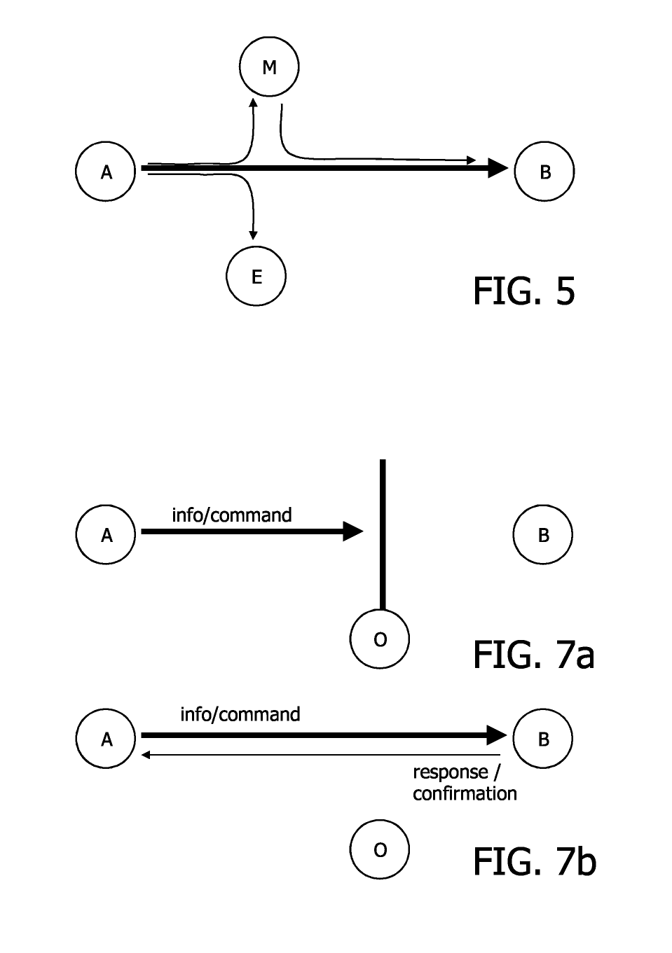

FIG. 5 illustrates two possible attacks to an unsecured communication,

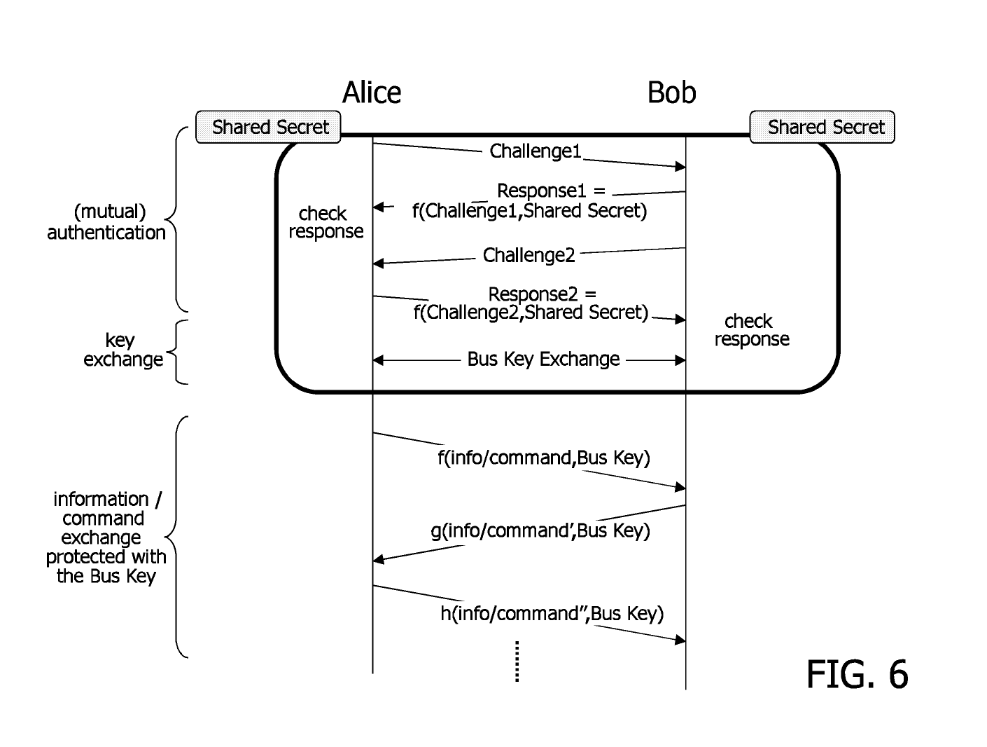

FIG. 6 shows a schematic flowchart of a challenge-response and key-exchange protocol,

FIG. 7 illustrates another possible attack to an unsecured communication,

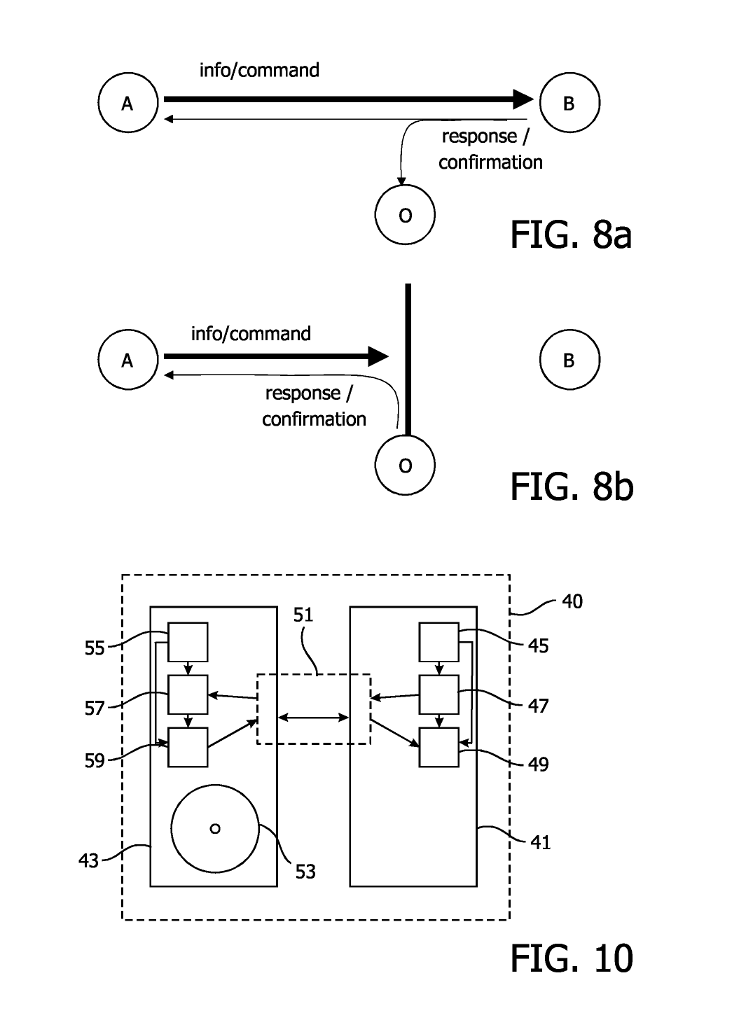

FIG. 8 illustrates a possible attack to a conventionally secured communication,

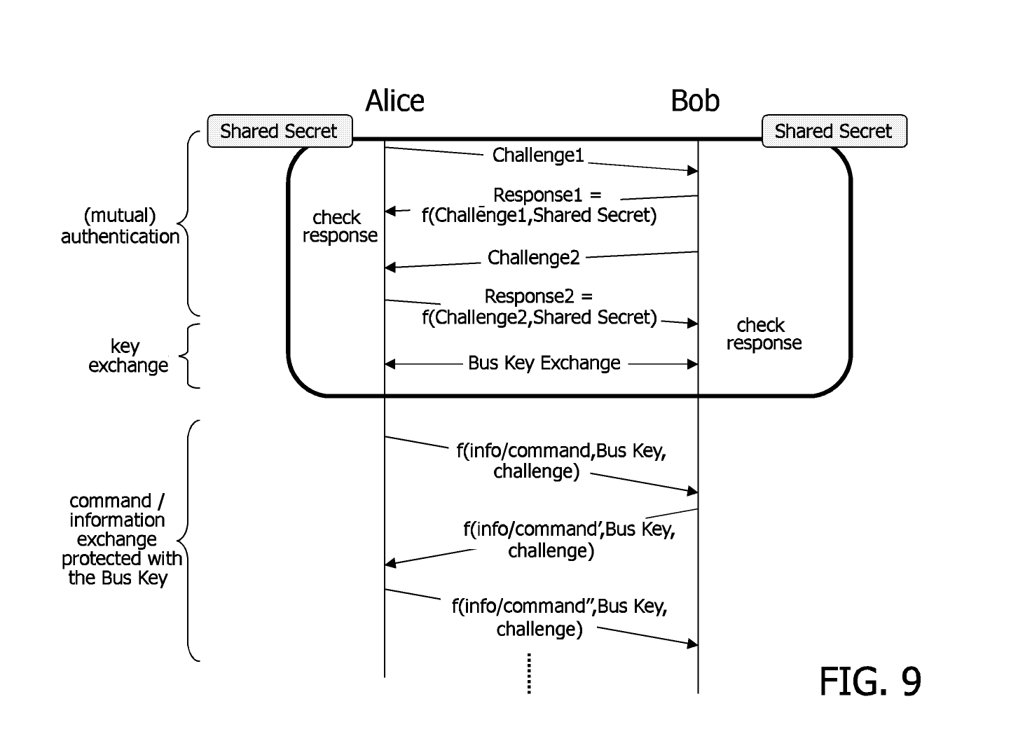

FIG. 9 shows a schematic flowchart of an enhanced communication protocol, and

FIG. 10 shows a digital rights management system according to the present invention.

FIG. 1 describes an example of the RE mark access protocol as an embodiment of a digital rights management method according to the present invention. The following description refers to RE marks, but, however, it has to be noted, that the present invention is not limited to RE marks as a special kind of hidden channel data and that it is also not limited to managing hidden channel data as a special kind of data for digital rights management. An application unit or host 1 and a drive or drive unit 3 are connected via suitable communication means (not shown). It has to be noted that in the following the term “host” will be used as synonymous to “application unit”, wherein the same applies to “drive” and “drive unit”. It is assumed that prior to this two-step protocol, drive 3 and host 1 have executed an authentication protocol that results in a shared bus key KB. An example of such an authentication protocol can be found in the VCPS specification.

To read, change, or wipe an RE mark value, the drive 3 and the host 1 must execute the following steps in the order of appearance.

The host 1 chooses an RE mark slot n to access, and an access-mode [mode=0 (read), 1 (change), 2 (wipe)]. Furthermore, the host 1 generates a random number RX (step 5). Then, the host sends the following message 7 to the drive 1:

(n ∥ mode ∥ RX ∥ sig)KB.

Here, the notation (M)K means that the message M is encrypted with a key K (preferably using a block cipher in Cipher Block Chaining (CBC) mode). In addition, sig is a known bit pattern, which is included for the purpose of checking the integrity of the message. Note that one reason to encrypt the message is to prevent unauthenticated applications to destroy the RE mark.

The drive 3 decrypts the message 7 received from the host 1 and checks the format of this message 7. If the format is incorrect, the drive 3 aborts the protocol. An incorrect format may either indicate a communication error or an attempt to manipulate the RE marks by using an incorrect bus key. Otherwise, if the message format and thus the authenticity of the message is verified (step 9), the drive executes the request encoded in the parameters n and mode (step 11).

Subsequently, the drive sends the following response message 13 to the host:

(n ∥ mode ∥ RMₙ ∥ RX)KB.

In this response message 13, RMₙ is the current value of the n^{th} RE mark value after a possible update. If mode=2 (wipe), the drive 3 may set RMₙ to all zeros.

The host 1 decrypts the response message 13 received from the drive 3 and checks the format of the message 13. If the random number RX and the parameters n and mode are not identical to the values that the host 1 has sent to the drive 3 in message 7, the host 1 aborts the protocol, and ignores the new value of the RE mark. Otherwise the new value RMₙ is accepted and used by the host 1 to protect DRM data. Note that if the drive 3 and/or the host 1 have aborted the protocol, a retry of the protocol must start from step 5.

FIG. 2 and FIG. 3 provide examples of MMC Parameter Data respectively Returned Data of Command Descriptor Blocks that implement the above described protocol (see also the VCPS specification for additional information on commands that are used in the authentication protocol).

The SEND KEY RE Mark command shown in FIG. 2 sends the request of the host 1 to read, change, or wipe a specific RE mark value. The SEND KEY RE Mark command provides the functionality of message 7 in the above protocol. The semantics of the SEND KEY RE Mark command are as follows:

If the drive-host authentication protocol has not finished successfully, the drive 3 terminates the command with CHECK CONDITION status. In addition, the drive 3 sets sense bytes SK/ASC/ASCQ to ILLEGAL REQUEST/COMMAND SEQUENCE ERROR (0x05/0x2C/0x00). After successful authentication, a retry of the protocol must start from step 5. The drive 3 checks that the requested RE mark is already contained on the disc. If not, it generates the RE mark with a value that has been generated randomly. If an unrecoverable error occurs while writing the RE mark, the drive 3 terminates the command with CHECK CONDITION status. In addition, the drive 3 sets sense bytes SK/ASC/ASCQ to ILLEGAL REQUEST/SYSTEM RESOURCE FAILURE (0x05/0x55/0x00). Otherwise, the drive terminates with GOOD status. All reserved bytes are set to 0x00 (Reserved) and the Data length is set to 38.

“Encrypted Message 1” contains parameters n (8 bits) and mode (8 bits), the random number RX from the host (112 bits), and the fixed bit pattern sig (128 bits), all encrypted using the bus key KB (previously obtained using an authentication protocol) using AES (see Advanced Encryption Standard, Federal Information Processing Publication (FIPS PUB) 197) in CBC mode.

The REPORT KEY RE Mark command shown in FIG. 3 returns the current (and potentially updated) value of the requested RE mark. The REPORT KEY RE Mark command provides the functionality of message 13 in the above protocol. The semantics of the REPORT KEY RE Mark command are as follows:

If the drive-host authentication protocol has not finished successfully, the drive 3 terminates the command with CHECK CONDITION status. In addition, the drive 3 sets sense bytes SK/ASC/ASCQ to ILLEGAL REQUEST/COMMAND SEQUENCE ERROR (0x05/0x2C/0x00). After successful authentication, a retry of the protocol must start from step 5. If the RE mark access sequence has been violated, or if the drive 3 has aborted the RE mark access protocol in step 9, the drive 3 terminates the command with CHECK CONDITION status. In addition, the drive 3 sets sense bytes SK/ASC/ASCQ to ILLEGAL REQUEST/COMMAND SEQUENCE ERROR (0x05/0x2C/0x00). After successful authentication, a retry of the protocol must start from step 5. Otherwise, the drive 3 returns the requested RE mark value within the response message 13, and terminates with GOOD status. All reserved bytes are set to 0x00 (Reserved) and the Data length is set to 38.

“Encrypted Message 2” contains parameters n (8 bits) and mode (8 bits), the specified RE mark value RMₙ (128 bits), and the random number RX sent previously by the host 1 (112 bits), all encrypted using the bus key KB (previously obtained using an authentication protocol) using AES in CBC mode.

FIG. 4 describes an alternative example of the RE mark access protocol similar to the embodiment shown in FIG. 1. Again, it is assumed that prior to this two-step protocol, drive 23 and host 21 have executed an authentication protocol that results in a shared bus key KB. The main difference with the protocol of the embodiment of FIG. 1 is that the RE mark value is not considered to be confidential data.

To read, change, or wipe an RE mark value, the drive 23 and the host 21 must execute the following steps in the order of appearance.

The host 21 chooses an RE mark slot n to access, and an access-mode [mode=0 (read), 1 (change), 2 (wipe)]. Furthermore, the host generates a random number RX (step 25). Then, the host 21 sends the following message 27 to the drive:

n ∥ mode ∥ RX ∥ hash(KB, M₁),

wherein M₁ is an abbreviation for n ∥ mode ∥ RX, and the hash function is a keyed-hash function using the shared bus key. It has to be noted that the hash function also may be of another kind and that an inclusion of the hash is optional. Its main purpose is to prevent unauthenticated applications to destroy the RE mark. The drive 23 checks the format of the received message 27 (step 29). If the format is incorrect, the drive aborts the protocol, since this either indicates a communication error or a hacking attempt. Otherwise, if the message 27 is thus verified, the drive 23 executes the request encoded in the parameters n and mode (step 31). Subsequently, the drive 23 sends the following response message 33 to the host 21:

RX ∥ RMₙ ∥ hash(KB, M₂),

wherein M₂ stands for RMₙ ∥ RX, and RMₙ is the current value of the n^{th} RE mark value after a possible update. If mode=2 (wipe), the drive sets RMₙ to all zeros. The host 21 checks the format of the received response message 33. If the random number RX is not identical to the value that the host has sent to the drive with message 27, the host 21 aborts the protocol, and ignores the new value of the RE mark. If the hash included in the message is not consistent with the remainder of the message 27, the host aborts the protocol, and ignores the new value of the RE mark. Otherwise the new value RMₙ is accepted and used by the host to protect DRM data. Note that, as in the above embodiment of FIG. 1, if the drive and/or the host have aborted the protocol, a retry of the protocol must start from step 25.

Parameter blocks and returned data blocks for MMC are similar to those of the example embodiment shown in FIG. 1, i.e. to those shown in FIGS. 2 and 3.

In the following a more abstract explanation of the present invention is given. Known from prior art are methods to secure a communication between Alice (A) and Bob (B) against two well-known attacks as illustrated in FIG. 5. It has to be noted that within the context of the present invention the sender Alice corresponds to the host or application unit sending a message, in particular a command related to digital rights management, to a receiver which corresponds to Bob. When Alice (A) sends a message to Bob (B), Eve (E) may try to eavesdrop, and steal the information in the message. Eve (E) is trying to steal the information that Alice transmits to Bob by eavesdropping, i.e. the confidentiality of the information is under attack. Mallory (M) will not only eavesdrop, but also will modify the message to Bob.

If Mallory (M) modifies the message that Alice transmits to Bob the integrity of the information is under attack.

The standard way to thwart these attacks is for Alice and Bob to engage in a protocol like the one below:

1. they share a secret prior to initiating communication; this shared secret can be re-used;
2. they perform the protocol steps shown in FIG. 6 before sharing the information under attack in FIG. 5. Roughly speaking, Alice verifies that she is talking to Bob by verifying his knowledge of the shared secret: he should be able to return a challenge sent by Alice mixed in the right way with their shared secret. Optionally, Bob can verify that he is connected to Alice in a similar way (mutual authentication). The term f(x, y, . . . ) indicates that the response or message is constructed using x, y, . . . , e.g. when x is data and y is a key f(x, y) may indicate a result of an encryption of x by means of y;
3. they continue by sharing a temporary secret, the Bus Key, e.g. using Diffie-Hellman key exchange as described in U.S. Pat. No. 4,200,770, possibly based on the challenges/responses from the previous two steps.

After this initial phase, information can now be shared securely between Alice and Bob by mixing the transmitted information with the bus key. Confidentiality is guaranteed by encrypting with the bus key, whereas integrity comes from attaching a Message Authentication Code (MAC) based on the bus key. The result is also known as a Secure Authenticated Channel (SAC).

As indicated in FIG. 6 there is a secret shared by both Alice and Bob. This shared secret is utilized for performing a (mutual) authentication wherein Alice sends a first request comprising a challenge to Bob. Bob generates a first response using said challenge and said shared secret and sends said response to Alice. Thus, by checking for the right generation of said response Alice is able to verify that she does actually communicate with Bob. The same applies to a second request from Bob and a second response from Alice. After the verification of the correct participants in the communication a bus key is exchanged between Alice and Bob. For a further communication said bus key is used as a shared secret

Apart from the attacks illustrated in FIG. 5, there exists a less common class of attacks in which information transmitted to Bob is being blocked or obstructed by Otto (O), see FIG. 7, part (a). Otto might be motivated to do this e.g. to block decrementing of digital rights or a withdrawal from his account. Although it is fundamentally impossible to prevent this attack, it is possible to construct the protocol such that Alice knows that she is being obstructed, e.g. by requiring Bob to acknowledge receipt of a transmission from Alice, see FIG. 7, part (b); Alice can then take alternative measures to punish Otto, e.g. cancel his account.

A problem with this straightforward solution is that not only Bob, but also Otto could generate this acknowledgement, even if it is cryptographically protected with the Bus Key: in a first round Otto allows Alice's transmission to go through, and he simply records the response from Bob. Subsequent transmissions from Alice are obstructed, but Otto replays the “confirmation” from Bob to give her the illusion that all is dandy, see FIG. 8. In part (a) Otto allows Alice's transmission to get through to Bob, so he can record Bob's confirmation. In part (b) Otto obstructs all subsequent transmissions from Alice, but gives her the illusion that her messages are getting through by replaying Bob's response from part (a).

One of the objectives of the present invention is to present a solution to the latter attack. The solution is the following: Alice should require the response from Bob to have the following generic form

response=f(Bus Key, security signature, other data)

where ‘Bus Key’ is the secret shared while the SAC is being set up, and ‘security signature’ is a binary string satisfying the following requirements:

the string should be long enough, typically >64 bits;

the string should be different for every info/command that Alice sends;

Alice should know or be able to compute the security signature. ‘Other Data’ is an optional payload of the response not relevant for this disclosure.

When receiving this response Alice should check that this response is in accordance with her own knowledge of ‘security signature’ and ‘Bus Key’. The purpose of the Bus Key is to prevent Otto from predicting what the correct response should be so he can execute the attack of FIG. 8. The purpose of the string is to prevent Otto from replaying an old response from Bob; to this end the signature should change every time. The signature should be long enough so that Otto cannot just guess the response with good probability just by picking a random number.

Some examples of the structure of such a response:

‘security signature’ is an integer which increases monotonically for every info/command that Alice sends, i.e. ‘security signature’ is the serial number of the commands,

‘security signature’ is of the form: secsig1 ∥payload[n] ∥ secsig2, where payload[n] is the payload of the n^{th} round of the protocol, and secsig1 and secsig2 are fixed strings. Alice keeps a record of all the payload[n]'s that she has received and checks (a) that the same payload has not been received twice and (b) secsig1 and secsig2 are as expected. This form of ‘security signature’ only works well if Bob only returns payloads which are virtually never the same. In the example of the RE-mark above this is the case.

‘security signature’ is a random number chosen randomly by Alice (a ‘challenge’), a new one for every round of the protocol, and forwarded to Bob in the info/command phase. Upon receipt of the response Alice checks that proper challenge is present in the response from Bob. FIG. 9 gives an example of this protocol. As the challenge is different for every block of information that Alice sends to Bob, the corresponding responses are also different; therefore Alice can detect whether Otto is replaying an old response from Bob or whether Bob himself is sending a fresh response.

FIG. 9 shows a possible security solution to the attack of FIG. 8, in which every transmission of Alice now includes a (random) challenge, which Bob needs to echo in his confirmation, properly mixed with the Bus Key of course.

The steps of a (mutual) authentication and of a key exchange shown in FIG. 9 are identical to those shown in FIG. 6. However, the further communication comprises pairs of message, i.e. pairs of a request and a response, wherein together with said request a challenge is given and wherein said challenge is again communicated with(in) said response. Since the challenge is cryptographically processed using said shared secret only known by Alice and Bob, the sender of the request is able to verify that the recipient has actually received the corresponding request. Preferably, that challenge is changed after each pair of request and response, i.e. the same challenge is virtually never used again with a request. This reduces the chances for breaking the secrecy of said shared secret by analyzing a number of messages and avoids the danger of a playback attack.

FIG. 10 shows a digital rights management system 40 according to the present invention comprising an application unit 41 and a drive unit 43. Said application unit 41 includes a first key storage unit 45 for storing a bus key, a request generation unit 47 and a response verification unit 49. Said drive unit 43 has a key storage unit 55 for storing said bus key, a request processing unit 57 and a response generation unit 59. Said drive unit 43 and said application unit 41 share a communication unit 51. Said drive unit is adapted for accessing a disc 53 with content subjected to a digital rights management, in particular for reading from and writing to a hidden channel of said disc 53.

During operation, said request generation unit 47 generates a request including a message and a challenge, wherein said message contains a digital rights management related command, e.g. a command for changing an RE mark on said disc 53. Said request is sent to said drive unit 43 via said communication unit 51. In case said request is found to be valid by said request processing unit 57, said request processing unit 57 is thus caused to, for instance, change said RE mark on said disc 53. This change gives a new value for said RE mark which is included together with an indication of said challenge in a response by said response generation unit 59. At least for the generation of said response said bus key is used, wherein it is preferable to also generate said request using said bus key. Said response is transmitted via said communication unit to said application unit 41. The validity of said response is checked by said response verification unit by checking for the presence of said indication of said challenge after a decoding of said response using said bus key. If said response is found to be valid, it is clear to said application unit 41 that said request has indeed been processed by said drive unit 43 and that the response was generated by said drive unit 43.

By a digital rights management system as BD-VCPS a secure storage of stateful rights, e.g. allowance of three times of playing and two copies, is provided on a disc. An optical side channel, e.g. the RE mark similar to the hidden channel used in the known DRM system, is employed for this purpose. Unlike the known DRM system, BD-VCPS does not define a key locker, but instead provides applications with a direct interface to the hidden channel. The inventors had the insight, that authentication between the application and the drive is not sufficient to provide a protection against various attacks with respect to hidden channel access. According to the invention, a solution to this problem consists in adding an additional challenge-response mechanism that has to be used for preferably every access to the hidden channel.

Although the invention has been elucidated with reference to the embodiments described above, it will be evident that other embodiments may alternatively be used to achieve the same object. The scope of the invention is therefore not limited to the embodiments described above, but can also be applied to other communication systems.

It should further be noted that the use of the verb “comprises/comprising” and its conjugations in this specification, including the claims, is understood to specify the presence of stated features, integers, steps or components, but does not exclude the presence or addition of one or more other features, integers, steps or components or groups thereof. It should also be noted that the indefinite article “a” or “an” preceding an element in a claim does not exclude the presence of a plurality of such elements. Moreover, any reference sign does not limit the scope of the claims; the invention can be implemented by means of both hardware and software, and several “means” may be represented by the same item of hardware. Furthermore, the invention resides in each and every novel feature or combination of features.

1-15. (canceled)

16. Application unit (1, 21, 41) for use in a digital rights management system (40) comprising a drive unit (3, 23, 43) for controlling access rights to copy protected content, said application unit (1, 21, 41) comprising:
a key storage unit (45) for storing a bus key (KB),
a request generation unit (47) for generating a request (7, 27) to be carried out by said drive unit including a message regarding said access rights and a challenge (RX),
a communication unit (51) for transmitting said request (7, 27) and for receiving a response (13, 33) to said request (7, 27) from said drive unit (3, 23, 43),
a response verification unit (49) for verifying a link between said request (7, 27) and said response (13, 33) by decoding said response (13, 33) using said bus key (KB) and by checking for the presence of an indication of said challenge (RX) in said response (13, 33) indicating that said request has been carried out.

17. Application unit (1, 21, 41) as claimed in claim 16, wherein said request generation unit (47) is adapted for cryptographically linking said message and said challenge (RX) by means of said bus key (KB).

18. Application unit (1, 21, 41) as claimed in claim 16, wherein said request generation unit (47) is adapted for including a signature (sig) into said request (7) for use in an integrity test of said request (7).

19. Application unit (1, 21, 41) as claimed in claim 16, wherein said request generation unit (47) is adapted for encrypting said request (7, 27) using said bus key (KB).

20. Application unit (1, 21, 41) as claimed in claim 16, wherein said request generation unit (47) is adapted for including a value derived from said challenge (RX) and/or said message and said bus key (KB) by means of a hash function, in particular by means of a keyed-hash function using said bus key (KB), into said request (7, 27).

21. Application unit (1, 21, 41) as claimed in claim 16, wherein said message includes a command for managing hidden channel entries, in particular a command for reading a hidden channel entry, for changing a hidden channel entry and/or for wiping a hidden channel entry.

22. Application unit (1, 21, 41) as claimed in claim 16, wherein said request generation unit (47) is adapted for including a random number, an identifier identifying said request (7, 27), in particular a unique identifier, and/or predetermined data as said challenge (RX) into said request (7, 27).

23. Application unit (1, 21, 41) as claimed in claim 16, wherein said application unit (1, 21, 41) is a host, in particular a software application.

24. Drive unit (3, 23, 43) for use in a digital rights management system (40) comprising an application unit (1, 21, 41) for controlling access rights to copy protected content, said drive unit (3, 23, 43) comprising:
a key storage unit (55) for storing a bus key (KB),
a communication unit (51) for receiving a request (7, 27) to be carried out by said drive unit including a message regarding said access rights and a challenge (RX) from said application unit (1, 21, 41) and for transmitting a response (13, 33) to said request (1, 21, 41),
a request processing unit (57) processing said message,
a response generation unit (59) for generating said response (13, 33) including an indication of said challenge (RX) and a reply to said message, wherein said indication of said challenge (RX) and said reply are cryptographically linked by means of said bus key (KB) and wherein indication of said challenge (RX) in said response (13, 33) indicates that said request has been carried out.

25. Drive unit (3, 23, 43) as claimed in claim 24, wherein said reply includes a hidden channel entry, in particular a hidden channel entry read or changed by said drive unit.

26. Digital rights management system (40) for controlling access rights to copy protected content comprising an application unit (1, 21, 41) for use in a digital rights management system (40) comprising a drive unit (3, 23, 43) for controlling access rights to copy protected content, said application unit (1, 21, 41) comprising:
a key storage unit (45) for storing a bus key (KB),
a request generation unit (47) for generating a request (7, 27) to be carried out by said drive unit including a message regarding said access rights and a challenge (RX),
a communication unit (51) for transmitting said request (7, 27) and for receiving a response (13, 33) to said request (7, 27) from said drive unit (3, 23, 43),
a response verification unit (49) for verifying a link between said request (7, 27) and said response (13, 33) by decoding said response (13, 33) using said bus key (KB) and by checking for the presence of an indication of said challenge (RX) in said response (13, 33) indicating that said request has been carried out and a drive unit (3, 23, 43) as claimed in claim 24, wherein said bus key (KB) is shared by said application unit (1, 21, 41) and said drive unit (3, 23, 43).

27. Digital rights management method for controlling access rights to copy protected content in a digital rights management system (40) comprising an application unit (1, 21, 41) and a drive unit (3, 23,43) sharing a bus key (KB), said method comprising the steps of:
a) generating (5, 25), by said application unit (1, 21, 41), a request (7, 27) to be carried out by said drive unit including a message regarding said access rights and a challenge (RX),
b) communicating said request (7, 27) from said application unit (1, 21, 41) to said drive unit (3, 23,43),
c) processing (11, 31) said message by said drive unit (3, 23,43),
d) generating, by said drive unit (3, 23,43), a response (13, 33) including an indication of said challenge (RX) and a reply to said message, wherein said indication of said challenge (RX) and said reply are cryptographically linked together by means of said bus key (KB),
e) communicating said response (13, 33) from said drive unit (3, 23, 43) to said application unit (1, 21, 41), and
f) verifying (15, 35), by said application unit (1, 21, 41), a link between said request (7, 27) and said response (13, 33) by decoding said response using said bus key (KB) and by checking for the presence of an indication of said challenge (RX) in said response (13, 33) indicating that said request has been carried out by said drive unit (3, 23,43).

28. Digital rights management method, further comprising a step of verifying (9, 29) said request (7, 27) after step b) and before step c).

29. A computer program comprising computer program code means for causing an application unit (1, 21, 41) in a digital rights management system (40), further comprising a drive unit (3, 23,43) sharing a bus key (KB) with said application unit to perform the following steps of a method as claimed in claim 27 when said computer program is run on said application unit:
generating (5, 25) a request (7, 27) to be carried out by said drive unit including a message regarding said access rights and a challenge (RX),
communicating said request (7, 27) from said application unit (1, 21, 41) to said drive unit (3, 23,43), said drive unit being adapted to process (11, 31) said message, to generate a response (13, 33) including an indication of said challenge (RX) and a reply to said message, wherein said indication of said challenge (RX) and said reply are cryptographically linked together by means of said bus key (KB), and to communicate said response (13, 33) from said drive unit (3, 23, 43) to said application unit (1, 21, 41), and
verifying (15, 35) a link between said request (7, 27) and said response (13, 33) by decoding said response using said bus key (KB) and by checking for the presence of an indication of said challenge (RX) in said response (13, 33) indicating that said request has been carried out by said drive unit (3, 23,43).

30. A computer program comprising computer program code means for causing a drive unit (3, 23,43) in a digital rights management system (40), further comprising an application unit (1, 21, 41) sharing a bus key (KB) with said drive unit, to perform the following steps of a method as claimed in claim 27 when said computer program is run on said drive unit:
receiving a request (7, 27) from said application unit (1, 21, 41), said request being generated by said application unit (1, 21, 41) for being carried out by said drive unit including a message regarding said access rights and a challenge (RX),
processing (11, 31) said message,
generating a response (13, 33) including an indication of said challenge (RX) and a reply to said message, wherein said indication of said challenge (RX) and said reply are cryptographically linked together by means of said bus key (KB),
communicating said response (13, 33) from said drive unit (3, 23, 43) to said application unit (1, 21, 41) for verifying (15, 35) a link between said request (7, 27) and said response (13, 33) by decoding said response using said bus key (KB) and by checking for the presence of an indication of said challenge (RX) in said response (13, 33) indicating that said request has been carried out by said drive unit (3, 23,43).
